(19) United States
(12) Patent Application Publication
(10) Pub. No.: US 2015/0243289 A1
(43) Pub. Date: Aug. 27, 2015

(54) Multi-Channel Audio Content Analysis Based Upmix Detection

(71) Applicant: DOLBY LABORATORIES LICENSING CORPORATION, San Francisco, CA (US)

(72) Inventors: Regunathan Radhakrishnan, Foster City, CA (US); Mark F. Davis, Pacifica, CA (US)

(73) Assignee: Dolby Laboratories Licensing Corporation, San Francisco, CA (US)

(21) Appl. No.: 14/427,879

(22) PCT Filed: Sep. 13, 2013
(86) PCT No.: PCT/US2013/059670

§ 371 Date: Mar. 12, 2015

Related U.S. Application Data
(60) Provisional application No. 61/701,535, filed on Sep. 14, 2012.

(51) Int. Cl. G10L 19/008

(52) U.S. Cl. CPC G10L 19/008

(57) ABSTRACT

Forensic audio upmixer detection is described. Feature sets are extracted from an audio signal that has two or more individual channels. Based on the extracted feature sets, it is determined whether the audio signal was upmixed from audio content that has fewer channels.

### TECHNOLOGY

The present invention relates generally to signal processing. More particularly, an embodiment of the present invention relates to forensic detection of upmixing in multi-channel audio content based on analysis of the content.

### BACKGROUND

Stereophonic (stereo) audio content has two channels, which in relation to their relative spatial orientation are typically referred to as ‘left’ and ‘right’ channels. Audio content with more than two channels is typically referred to as ‘multi-channel’ content. For example, ‘5.1’ and ‘7.1’ (and other) multi-channel audio systems produce a sound stage that users with normal binaural hearing may perceive as “surround sound.” A typical 5.1 multi-channel audio system has five channels, which in relation to their relative spatial orientation are typically referred to as ‘left’ (L), ‘right’ (R), ‘center’ (C), left-surround′ (Ls), ‘right-surround’ (Rs) and a ‘low frequency effect’ (LFE) channel. Multi-channel audio content may comprise various components.

For example, the audio content of a movie soundtrack may comprise speech components (e.g., conversations between actors), ambient natural sound components (e.g., wind noise, ocean surf), ambient sound components that relate to a particular scene (e.g., machinery noises, animal and human sounds like footsteps or tapping) and/or musical components (e.g., background music, musical score, musical voice such as singing or chorale, bands and orchestras in the scene). Some of the audio content components may be typically associated with a particular audio channel. For example, speech related components are frequently rendered in the center channel, which drive the center loudspeakers (which are sometimes positioned behind a projection screen). Thus, an audience may perceive the speech in spatial correspondence with the persons “speaking on the screen.”

Multi-channel audio content may be recorded directly as such or it may be generated from an instance of the content, which itself comprises fewer channels. Processes with which a multi-channel audio content instance is generated from a content instance that has fewer channels is typically referred to as upmixing. Thus for example, stereo content may be upmixed to 5.1 content. Upmixers analyze input stereo content and estimate direct and ambient signal components. Based on the estimated direct and ambient signal components, the upmixers generate signals for each of the individual output channels. The signals that are generated for each of the individual output channels then drives the corresponding L, R, C, Ls, or Rs loudspeaker.

Multi-channel audio content derived from upmixers also comprises characteristic features such as relationships between channel pairs. For example, pairs of channels (L/R, Ls/Rs, L/Ls, R/Rs, L/C, R/C, etc.) may share certain relative phase orientations, relative inter-channel time delays, cross-channel correlations and/or other characteristics. Some of characteristics of a particular piece of content or a portion thereof may be unique thereto. Moreover, the characteristics of a particular content instance may be unique in relation to the corresponding characteristics of another instance of that same content. Thus for example, the characteristics an upmixed instance of a portion of 5.1 content may differ somewhat, perhaps significantly, from the characteristics of an original instance of the same 5.1 content portion. Further, characteristics of each individual instance of the same content portion, which are upmixed independently with different upmixer processes or platforms may also differ somewhat, perhaps significantly, from each other.

The approaches described in this background section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF THE DRAWINGS

An embodiment of the present invention is illustrated by way of example, and not in way by limitation, in the figures of the accompanying drawings and in which like reference numerals refer to similar elements and in which:

FIG. 1 depicts an example forensic upmixer identity detection system, according to an embodiment of the present invention;

FIG. 2A depicts a flowchart of an example process for rank analysis based feature detection, according to an embodiment of the present invention;

FIG. 2B depicts a first comparison of rank estimates, based on an example implementation of an embodiment of the present invention;

FIG. 3 depicts an example process for computing a speech leakage feature, according to an embodiment of the present invention;

FIG. 4 depicts a plot of signal energy leakage from various multichannel content examples;

FIG. 5A and FIG. 5B depict respectively an example low-pass filter response and an example shelf filter frequency response;

FIG. 6 depicts an example time delay estimation between a pair of audio channels;

FIG. 7 and FIG. 8 depict example correlation values distributions for an example upmixer in two respective operating modes;

FIG. 9 depicts an example computer system platform, with which an embodiment of the present invention may be practiced; and

FIG. 10 depicts an example integrated circuit (IC) device, with which an embodiment of the present invention may be practiced.

### DESCRIPTION OF EXAMPLE EMBODIMENTS

Forensic detection of upmixing in multi-channel audio content based on analysis of the content is described herein. In the following description, for the purposes of explanation, numerous specific details that relate to one or more example embodiments are set forth in order to provide a thorough understanding of the present invention. It will be apparent, however, that the present invention may be practiced without these specific details. In other instances, for clarity, brevity and simplicity, and in order to avoid unnecessarily occluding, obscuring, or obfuscating the present invention, well-known structures and devices are not described in exhaustive detail.

Overview

Example embodiments described herein relate to forensic detection of upmixing in multi-channel audio content based on analysis of the content. Forensic audio upmixer detection is described. Feature sets are extracted from an audio signal that has two or more individual channels. Based on the extracted feature sets, it is determined whether the audio signal was upmixed from audio content that has fewer channels. The determination allows generalized detection that upmixing was involved in generating multi-channel audio, as well as identification of a particular upmixer that generated the accessed audio signal. The upmixing determination includes computing a score for the extracted features based on a statistical learning model, which may be computed based on an offline training set. The statistical learning model is described herein in relation to Adaptive Boosting (AdaBoost). Embodiments however may be implemented using a Gaussian Mixture Model (GMM), a Support Vector Machine (SVM) and/or another machine learning process.

The extracted features may include one or more of a rank analysis of the accessed audio signal, an analysis of a leakage of at least one component of the signal over the two or more channels of the accessed audio signal, an estimation of a transfer function between at least a pair of the two or more channels, an estimation of a phase relationship between at least a pair of the two or more channels, and/or an estimation of a time delay relationship between at least a pair of the two or more channels. The estimation one or more of the time delay relationship or the phase relationship is estimated by computing a correlation between each of the channels of the pair.

The rank analysis may be performed in a time domain on the accessed audio signal broadly and/or in each of multiple frequency bands, which correspond to the two or more channels of the accessed audio signal. Upon performing the wideband time domain based rank analysis and the rank analysis in each of the corresponding frequency bands, these analysis may be compared. Each of the channels of the channel pair may be aligned in time (e.g., temporally), after which an embodiment performs the rank analysis.

An embodiment may repeat a rank analysis. For example, a first rank analysis may be performed initially to obtain a first rank estimate, after which an inverse decorrelation may be performed over at least a pair of surround sound channels (e.g., Ls, Rs) of the accessed audio signal. Upon the inverse decorrelation performance, the rank analysis may be repeated to obtain a second rank estimate. The first and second rank estimates may then be compared.

Signal component leakage analysis includes classifying an extracted feature as pertaining to a leakage of one or more components of the audio signal between channels. Some particular audio signal components are typically associated with, and thus expected to be found in, a particular channel or group of channels, e.g., in a discrete instance of multi-channel audio content, in a channel other than that with which it is associated.

For example, speech related signal components are often or typically associated with the center (C) channel in discrete multi-channel audio, such as an original instance of the content. Where leakage analysis indicates that a feature extracted from audio content relates to speech components present contemporaneously (simultaneously) in each of at least two of the channels of the audio signal, the analysis may indicate that the content was upmixed, e.g., that the content comprises other than a discrete or original instance thereof. Moreover, one or more of the at least two channels in which the speech components are found comprises a channel other than a center (C) channel, such as one or more of the L and R channels or surround sound channels.

In contrast to an audio signal's speech related components per se, musical voice related signal components such as harmony singing or chorale may be concentrated typically in the L and R channels of discrete multi-channel audio content. Other more speech-like musical voice components such as solos, lyricals, operatics and the like may be in the C channel. Where signal leakage analysis indicates that a feature extracted from audio content relates to chorale or sung vocal harmony signal components, which are expected in one or more channels (e.g., L and R), present in one or more other channels (e.g., Ls, Rs or C) where their placement is unexpected (or e.g., in discrete multi-channel content, atypical), the analysis may also indicate that the content was upmixed.

In contrast as well to speech components, some signal components such as those that correspond to ambient, background or other scene sounds (including, e.g., intentional scene noise) may be typically concentrated in one or more off-center (e.g., non-C; L, R, Ls and/or Rs) channels in discrete multi-channel content. Where signal leakage analysis indicates that a feature extracted from audio content relates to the presence of these components in the C channel, the analysis may also indicate that the content was upmixed.

The transfer function estimation may be based on a cross-power spectral density and/or an input power spectral density, as well as an algorithm for computing least mean squares (LMS).

The upmixing determination may further include analyzing the extracted features over a duration of time and computing a set of descriptive statistics based on the analyzed features, such as a mean value and a variance value that are computed over the extracted features.

Embodiments also relate to systems and non-transitory computer readable storage media, which respectively process or store encoded instructions for performing, executing, controlling or programming forensic detection of upmixing in multi-channel audio content based on analysis of the content.

Upmixers analyze input stereo content and estimate direct and ambient signal components. Based on the estimated direct and ambient signal components, the upmixers generate signals for each of the individual output channels. A variety of modern upmixer applications are in use, including proprietary upmixers such as Dolby Pro Logic™, Dolby Pro Logic II™, Dolby Pro Logic IIx™ and the Dolby Broadcast Upmixer™, which are commercially available from Dolby Laboratories, Inc.™ (a corporation doing business in California). The processing and filtering operations performed in upmixing may impart characteristic features to the upmixed content and some of the characteristics may be detected therein, e.g., as artifacts of the upmixer. The characteristics of each individual instance of the same content portion, which are upmixed independently with different upmixer processes or platforms may also differ somewhat, perhaps significantly, from each other.

Embodiments of the present invention are described herein with reference to upmixers, which generate 5.1 multi-channel audio content from stereo content and in some instances, with reference to one or more of the Dolby Pro Logic™ upmixers. For clarity, consistency, brevity and simplicity, such reference to stereo-5.1 upmixers in this description represents, encompasses and applies to any upmixer however, proprietary or other, including those which generate quadrophonic (quad), 7.1, 10.2, 22.2 and/or other multi-channel audio content from corresponding audio content of fewer channels such as stereo. The example 5.1 multi-channel audio is described herein with reference to the L, C, R, Ls and Rs channels thereof; further discussion the LFE channel herein is omitted for clarity, brevity and simplicity.

An example embodiment functions to blindly detect an upmixer based on analysis of a piece of multi-channel content that is derived from the upmixer. Given a content portion such as a temporal chunk (e.g., 10 seconds) of multi-channel L, C, R, Ls, Rs content, a set of features is derived therefrom. The features include those that capture relationships such as time delays, phase relationships, and/or transfer functions that may exist between channel pairs. The features may also include those that capture speech leakage from a channel (e.g., typically C channel) into one or more other channels upon upmixing and/or a rank analysis of a covariance matrix, which is computed from the input multi-channel content. To create a statistical model of the distribution of these features for a particular upmixer (e.g., Dolby Prologic II™), an embodiment creates an off-line training dataset that comprises positive examples, such as multi-channel content that is derived from that particular upmixer, and negative examples, such as multi-channel content that is not derived from that upmixer (e.g., an original content instance or content that may have been created using a different upmixer). Using this training data, an embodiment learns a statistical model to detect a particular upmixer based on these features.

Given a novel test clip of multi-channel content, the same features are extracted that were used during the statistical learning procedure and a probability value is computed of these features occurring under a set of competing statistical models for the characteristics, effects and behavior of upmixers in relation to artifacts of their processing functions on content that has been upmixed therewith. The statistical model under which the computed features have maximum likelihood is identified, e.g., declared forensically to comprise that upmixer, which created the received input multi-channel content. Such forensic information may be used upon detection of particularly upmixed content to control, call, program, optimize, set or configure one or more of aspects of various audio processing applications, functions or operations that may occur subsequent to the upmixing, e.g., to optimize perceived audio quality of the upmixed content. Examples that relate to features that embodiments extract, and the statistical learning framework used therewith, are described in more detail, below.

An embodiment of the present invention identifies (e.g., detects forensically the identity of) a particular upmixer based on characteristic features of multi-channel audio content, which has been upmixed therewith. The characteristic features are learned from analyzing a variety of multi-channel content, which is created by the particular upmixer. Upon learning the characteristic features imparted with a particular upmixer, an embodiment stores the analysis-learned characteristic features. The various features are derived (e.g., extracted) from the input multi-channel content that is received, including features that capture relationships between channels, speech leakage into other channels, the rank of a covariance matrix that is computed from the multi-channel content. The extracted features are combined using a machine learning approach.

An embodiment implements the machine learning component with computations that are based on an Adaptive Boosting (AdaBoost) algorithm, a Gaussian Mixture Model (GMM), a Support Vector Machine (SVM) or another machine learning process. While example embodiments are described herein with reference to the AdaBoost algorithm for clarity, consistency, simplicity and brevity, the description represents, encompasses and applies to any machine learning process with which an embodiment may be implemented, including (but not limited to) AdaBoost, GMM or SVM. The Adaboost (or other) machine learning process functions in an embodiment to learn one or more classifiers, with which to discriminate between content derived from a particular upmixer and all other multi-channel content. The learned classifiers are stored for use in testing multi-channel content that is derived from a particular upmixer that has produced the multi-channel content from which the classifiers are learned. Moreover, the stored learned classifiers may be used to identify forensically the upmixer that has upmixed a particular piece of multi-channel audio content.

An example embodiment relates to forensically detecting an upmixing processing function performed over the media content or audio signal. For example, an embodiment detects whether an upmixing operation was performed, e.g., to derive individual channels in a multi-channel content, e.g., an audio file, based on forensic detection of relationship between at least a pair of channels. An embodiment may also identify a particular upmixer that upmixed a given piece of multi-channel content or a certain multi-channel audio signal.

The relationship between the pair of channels may include, for instance, a time delay between the two channels and/or a filtering operation performed over a reference channel, which derives one of multiple observable channels in the multichannel content. The time delay between two channels may be estimated with computation of a correlation of signals in both of the channels. The filtering operation may be detected based, at least in part, on estimating a reference channel for one of the channels, extracting features based on a transfer function relation between the reference channel and the observed channel, and computing a score of the extracted features based, as with one or more other embodiments, on a statistical learning model, such as a Gaussian Mixture Model (GMM), AdaBoost or a Support Vector Machine (SVM).

The reference channel may be either a filtered version of one of the channels or a filtered version of a linear combination of at least two channels. In an additional or alternative embodiment, the reference channel may have another characteristic. As in one or more embodiments, the statistical learning model may be computed based on an offline training set.

### Example Forensic Upmixer Detection System

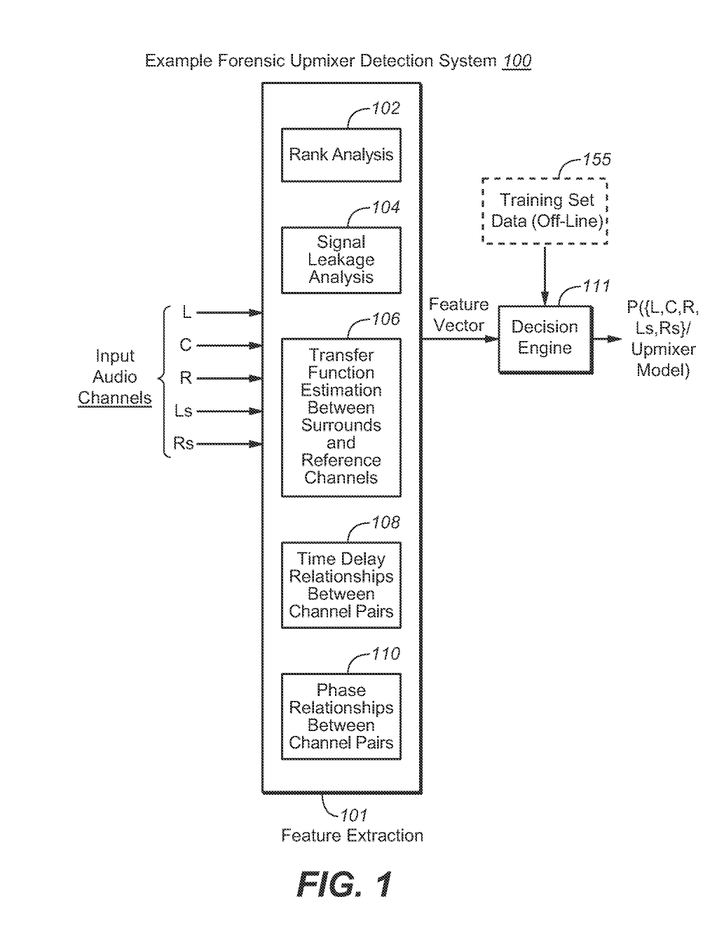

FIG. 1 depicts an example forensic upmixer identity detection system 100, according to an embodiment of the present invention. Forensic upmixer identity detection system 100 identifies a particular upmixer based on characteristic features of multi-channel audio content, which has been upmixed therewith. The characteristic features are learned from analyzing a variety of multi-channel content, which is created by the particular upmixer. A machine learning processor 155 (e.g., AdaBoost) functions off-line in relation to a real time identity detection function of system 100. The machine learning process is described in somewhat more detail, below. Upon learning the characteristic features that one or more particular upmixer types impart over given pieces of test content, the analysis-learned characteristic features may be stored. In an embodiment, features that are extracted from audio content for analysis include features that are based on a rank analysis, features based on signal leakage analysis and transfer signal analysis.

Forensic upmixer identity detection system 100 performs a real time function, wherein a particular upmixer is identified by detecting and analyzing characteristic features imparted therewith over input multi-channel audio content, which is received as an input to the system. Feature extraction component 101 receives an example 5.1 multi-channel input, which comprises individual L, C, R, Ls and Rs channels.

Feature extractor 101 comprises a rank analysis module 102, a signal leakage analysis module 104, a transfer function estimator module 106, a time delay detection module 108 and a phase relationship detection module 110. Based on a function of one or more of these modules, feature extractor 101 outputs a feature vector to a decision engine 111. Decision engine 111 computes a probability of the feature vector corresponding to the input channels to one or more statistical models that are learned off-line from test content. The computed probability provides a measurably accurate: (1) identification of a particular upmixer that produced a given piece of input content, or (2) detection that a particular instance of input content was upmixed with a certain upmixer.

### Example Rank Analysis Based Feature Extraction Process

To create multi-channel content, upmixers estimate direct signal components and ambient signal components from stereo content. In general, upmixers that derive multi-channel content from stereo can be described according to Equation 1, below.

y=Ax (1)

In Equation 1, the variable ‘x’ represents a 2×1 column vector, which represents signal components from the input L and R stereo channels. The coefficient ‘A’ represents a N×2 matrix, which routes the two input signal components to a whole number ‘N’ (which is greater than two) of output channels. The product ‘y’ comprises a N×1 output column vector, which represents signal components of the N output channels of the upmixer. The product y comprises a linear combination of the two independent signals in x. Thus, the inherent rank of the product y does not exceed two (2).

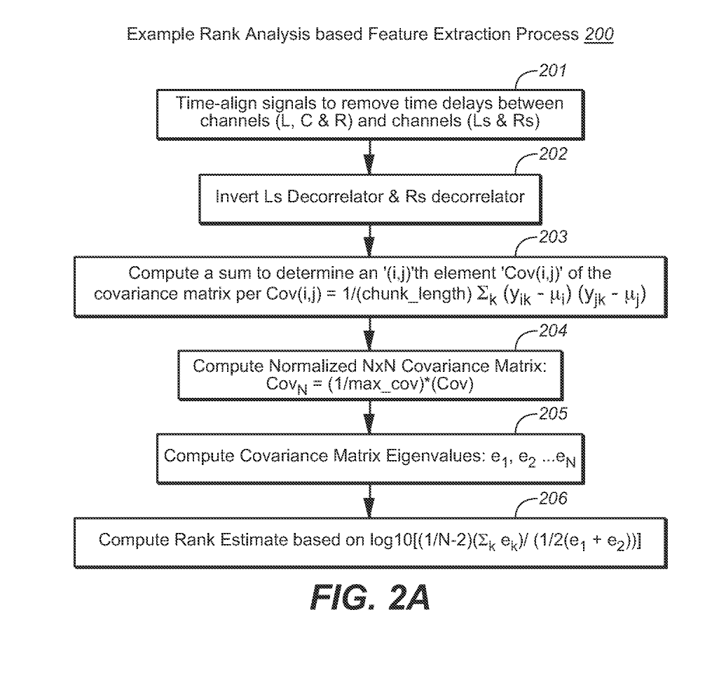

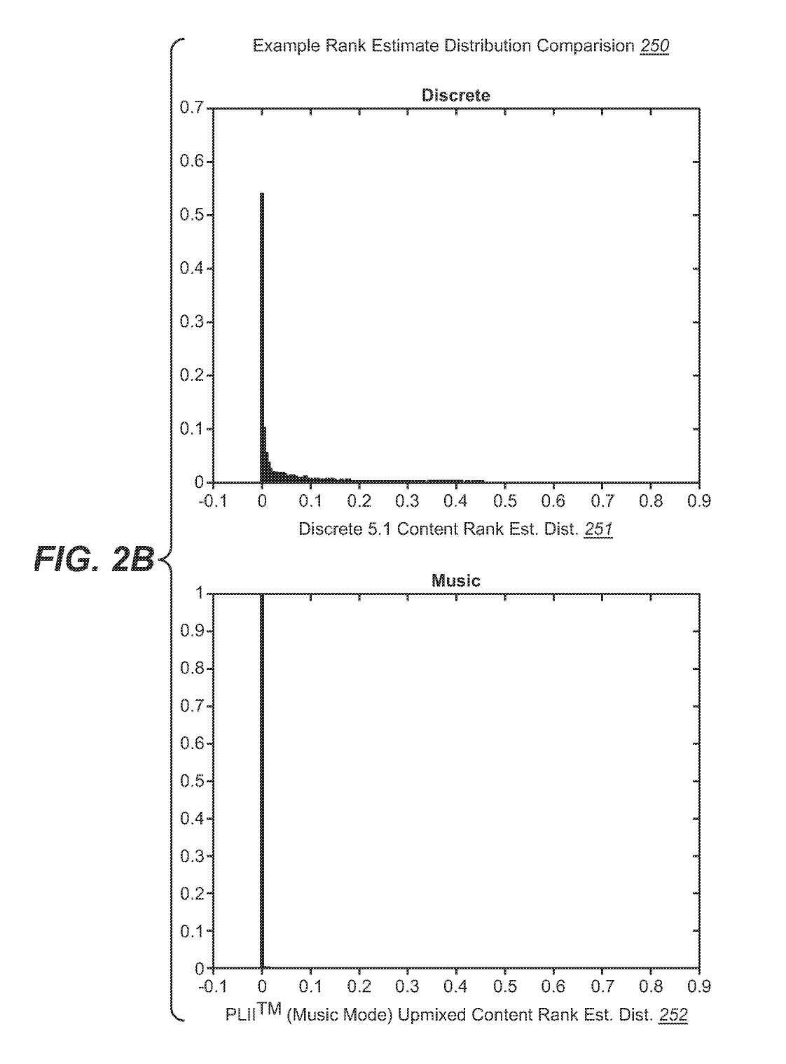

FIG. 2A depicts a flowchart of an example process 200 for rank analysis based feature detection, according to an embodiment of the present invention. Estimating the rank of y from its covariance matrix allows determination of whether the N output channel signal has low rank or not. For example, a “chunk” or temporal portion of audio content may be sampled over the duration of the temporal portion. The audio content chunk may be sampled discretely at a certain sample rate such as 48,000 samples per second (s). A chunk of audio content with a 10 s duration thus corresponds to a chunk_length ‘L’=(10 s)*(48 samples/s)=48,000 samples, from which its covariance matrix may be estimated. Prior to computing the rank estimation from the covariance matrix, the signals in the N upmixer output channels are aligned in time and decorrelators on the Ls and Rs surround channels are inverted.

In step 201, the signals in the output y are temporally aligned to remove time delays, which may sometimes be introduced between front (e.g., L, C and R) channels and the surround (e.g., Ls and Rs) channels. For example, Dolby Prologic™ and some other upmixers introduce a 10 ms or so delay between the surround channels Ls and Rs and the front channels L, C and R. An embodiment functions to remove these delays before computing the rank estimation.

In step 202, the decorrelators on the surround channels Ls and Rs are inverted to allow for decorrelator differences that exist between them. For instance, the Dolby Broadcast Upmixer™ uses a first decorrelator for channel Ls and a second decorrelator, which differs from the first decorrelator, for channel Rs. An embodiment applies an inverse function of the Ls first decorrelator and an inverse function of the Rs second decorrelator to allow for the differences between the decorrelators of each of the surround channels prior to computing the rank estimation.

In step 203, a sum is computed, which determines an element of the covariance matrix. An embodiment computes a sum to determine an ‘(i,j)’th element ‘Cov(i,j)’ of the covariance matrix according to Equation 2, below.

Cov(i,j)=1/(chunk_length)Σₖ(yᵢₖ−μᵢ)(yⱼₖ−μⱼ) (2)

In Equation 2, the variable μᵢ, and μⱼ represent respectively means of the sample values from channel ‘i’ and channel ‘j’ and ‘k’ represents a range of durations of portions of the chunk from 1 through a maximum chunk_length: k=1, 2, . . . , chunk_length.

In step 204, the normalized covariance matrix Cov_{N}=(1/max_cov)*(Cov) is computed, in which ‘max_cov’ represents the maximum value in the N×N covariance matrix.

In step 205, Eigenvalues e₁, e₂ . . . e_{N} of this N×N Cov_{N} matrix are computed.

In step 206, an embodiment computes the rank estimate feature is computed according to Equation 3, below.

rank_estimate=log 10[(1/N−2)(Σₖeₖ)/(½(e₁+e₂))]. (3)

In Equation 3, ‘k’ ranges from k=3, 4, . . . , N. The numerator ‘(1/N−2)(Σₖeₖ)’ denotes a measurement of the average energy in the Eigenvalues starting from 3 through N. The denominator ½(e₁+e₂) denotes a measurement of the average energy over the first 2 significant eigenvalues. For a rank equal to 2, the ratio (1/N−2)(Σₖeₖ)/(½(e₁+e₂)) is equal to zero. Values larger than zero for this ratio indicates that a rank is greater than 2.

FIG. 2B depicts a first comparison 250 of rank estimates, based on an example implementation of an embodiment of the present invention. Distribution 251 plots example rank estimates for discrete 5.1 content, e.g., an original instance of 5.1 content, that was created as such (and thus not upmixed from stereo content). Distribution 252 plots example rank estimates for 5.1 content that has been upmixed from stereo content using a Dolby Prologic II™ (PLII™), which processed the source stereo content in a ‘Music’ focused operational mode. Comparison 250 shows that PLII™ upmixed 5.1 content comprises rank estimate values that are close to zero over more than 99% of the 10 s content chunks. In contrast, comparison 250 shows that the discrete 5.1 content rank estimates comprise values that exceed 2 for about 50% of the 10 s content chunks. An embodiment uses the computed rank estimate feature to distinguish between upmixers that have different properties or characteristics and/or to detect use of a particular decorrelator during upmixing.

For example, an embodiment uses the rank_estimate feature to distinguish between a first upmixer that has wideband operational characteristics such as Dolby Prologic™ upmixers and a second upmixer, which has multiband operational characteristics such as the Dolby Broadcast Upmixer™. In characterizing wideband upmixers like Prologic™, the variables y and x comprise time domain samples in Equation 1 (y=Ax), above. In contrast, multiband upmixers like the Broadcast Upmixer™ are characterized with the variables y and x both comprising subband energies in Equation 1 and the mixing matrix coefficient A therein may vary over the different subbands.

An embodiment functions to distinguish between a wideband and multiband upmixer with processing that computes and compares the rank estimates associated with each. A first rank estimate (rank_estimate_{—}1) is computed from a covariance matrix that is estimated from time domain samples. A second rank estimate (rank_estimate_{—}2) is computed from a covariance matrix that is estimated from subband energy values. Wideband upmixing is detected with values that are computed for rank_estimate_{—}1 match, equal or closely approximate values that are computed for rank_estimate_{—}2. Multiband upmixing, in contrast, is detected with values that are computed for rank_estimate_{—}1 that exceed the values that are computed for rank_estimate_{—}2, and/or values that are computed for rank_estimate_{—}2 that more closely approach or approximate a value of zero (0), which corresponds to a rank of 2.

For another example, an embodiment functions using the rank_estimate feature to detect a particular decorrelator, which was used on the surround channels Ls and Rs during upmixing. Some upmixers such as the Dolby Broadcast Upmixer™ use a pair of matched, complementary or supplementary decorrelators on each of the left surround Ls signals and the right surround Rs signals to provide more diffuse sound field. Thus, for a rank_estimate_{—}1 based on a covariance matrix that is estimated from time domain samples, the rank estimate will exceed 2 because the decorrelated surround channels Ls and Rs have not been accounted for.

An embodiment performs inverse decorrelation over each of the surround channels Ls and Rs using the “correct” decorrelator, e.g., the decorrelator that was used during upmixing. The rank estimate is thus computed based on time domain samples of the inverse-decorrelated channels Ls and Rs, which achieves a rank estimate that more closely approximates a value of 2. An embodiment thus detects or identifies a specific decorrelator used on the surround channels Ls and Rs by:
computing rank_estimate_{—}1 based on a covariance matrix, which is estimated from time domain samples;
performing inverse decorrelation processing over left surround channel Ls and right surround channel Rs; and
computing rank_estimate_{—}2 based on a covariance matrix that is estimated from time domain samples after inverse decorrelation.
   If the right channel Rs decorrelator is used for inverse decorrelation, then the value of rank_estimate_{—}1 exceeds the value of rank estimate 2. However, if no decorrelation is applied over the surround channels during upmixing, then rank_estimate_{—}2 exceeds rank_estimate_{—}1.

FIG. 2C depicts a second comparison 275 of rank estimates, based on an example implementation of an embodiment of the present invention. Distribution 276 plots the distribution of rank_estimate_{—}1 for a Dolby Broadcast Upmixer™ before performing inverse decorrelation. Distribution 277 plots the distribution of rank_estimate_{—}2 for the same upmixer after performing inverse decorrelation.

### Example Signal Leakage Analysis Process

Upmixers may typically have difficulty performing sound source separation. In fact, some upmixers are unable to separate sound sources. Given a two channel stereo input signal, upmixers typically attempt to estimate a first group of sub-band energies that belong to a dominant sound source and a second group of sub-bands that belong to more ambient sounds. This estimation is usually performed based on correlation values that are computed band-by-band between the L and R stereo channels. For instance, if the correlation is high in a particular band, then that band is assumed to have energy from a dominant sound source.

Typically therefore, not more than a small fraction of energy from a highly correlated band would be directed to the Ls and Rs surround channels. Upmixers however are typically not very aggressive in directing all of the energy in a particular band to either the dominant source or the ambience. Leakage of the dominant signal to all channels is thus not uncommon. An embodiment detects such leakage to characterize a particular upmixer and to differentiate upmixed content from discrete 5.1 content (e.g., an original instance of 5.1 content created, recorded, etc. as such).

As described above, signal component leakage analysis includes classifying an extracted feature as pertaining to a leakage of one or more components of the audio signal between channels. Some particular audio signal components are typically associated with, and thus expected to be found in, a particular channel or group of channels, e.g., in a discrete instance of multi-channel audio content, in a channel other than that with which it is associated.

As described above, speech related signal components are often or typically associated with the center (C) channel in discrete multi-channel audio, such as an original instance of the content. Where leakage analysis indicates that a feature extracted from audio content relates to speech components present contemporaneously (simultaneously) in each of at least two of the channels of the audio signal, the analysis may indicate that the content was upmixed, e.g., that the content comprises other than a discrete or original instance thereof. Moreover, one or more of the at least two channels in which the speech components are found comprises a channel other than a center (C) channel, such as one or more of the L and R channels or surround channels.

Also as described above in contrast to an audio signal's speech related components per se, musical voice related signal components such as harmony singing or chorale may be concentrated typically in the L and R channels of discrete multi-channel audio content. Other more speech-like musical voice components such as solos, lyricals, operatics and the like may be in the C channel. Where signal leakage analysis indicates that a feature extracted from audio content relates to chorale or sung vocal harmony signal components, which are expected in one or more channels (e.g., L and R), present in one or more other channels (e.g., Ls, Rs or C) where their placement is unexpected (or e.g., in discrete multi-channel content, atypical), the analysis may also indicate that the content was upmixed. Thus, where a discrete instance of the multi-channel audio content comprises a musical voice component in at least a complementary pair of channels, wherein the signal component leakage analysis is performed over a feature that relates to detecting or classifying the musical voice related component in at least one channel other than the complementary channel pair, the analysis may also indicate that the content was upmixed.

Further as described above in contrast as well to speech components, some signal components such as those that correspond to ambient, background or other scene sounds (including, e.g., intentional scene noise) may be typically concentrated in one or more off-center (e.g., non-C; L, R, Ls and/or Rs) channels in discrete multi-channel content. Where a discrete instance of the multi-channel audio content comprises one or more of acoustic components that relate to one or more of an ambient, or scene, sound or noise in at least one particular channel and a signal leakage analysis is performed over a feature extracted from audio content, which relates to the presence of these acoustic components in the C channel, the analysis may also thus indicate that the content was upmixed.

An embodiment functions to detect how various upmixers cause leakage of a speech signal or speech related component of an audio content signal into the upmixed channels of 5.1 content. For discrete (e.g., original instance, created/recorded/stored as such) 5.1 content such as movies or drama, speech related signal components such as dialogue or soliloquy are usually concentrated in the center channel, while music, sound effects and ambient sounds are mixed in the L, R, Ls and Rs channels. However, a discrete instance of 5.1 content may be downmixed to stereo and then, that downmixed stereo content may then be subsequently upmixed to another (e.g., non-original, derivative) instance of the 5.1 content.

When discrete 5.1 content is downmixed to stereo and the stereo content is subsequently upmixed to derivative 5.1 content, the derivative content may differ from the original, discrete 5.1 content in one or more characteristic features. For example, relative to the discrete 5.1 content, speech related components in the subsequently upmixed derivative 5.1 content seem to shift, or leak into other (e.g., non-C) channels. Thus, when analyzed or when heard in a cinema soundtrack, speech related components in the upmixed 5.1 content that leaked from the C channel (e.g., in the original or discrete instance 5.1 content) into one or more of the L, R, Ls and/or Rs upon upmixing channels may not originate acoustically from a sound source in spatial alignment with the apparent speaker. Detecting such leakage can detect upmixed content and/or to distinguish upmixed 5.1 content from a discrete or original instance of 5.1 content in general and more particularly, may identify a certain upmixer that has upmixed the stereo into the upmixed 5.1 content instance.

An embodiment functions to analyze how the function of different upmixers cause a speech signal, or a speech related component in a compound (e.g., mixed speech/non-speech) audio signal, to leak into the upmixed channels. In discrete 5.1 content such as original 5.1 instances of movies and/or drama, dialogue and other speech and speech related components is usually placed in the center channel C, while music, other audio content components, and effects are mixed in the other channels L, R, Ls and Rs. However, when discrete 5.1 content is downmixed to stereo and upmixed using an upmixer such as Prologic™ or a broadcast upmixer, the resulting upmixed content has speech leaking into L, R, Ls and Rs when there is speech present originally in the center channel C.

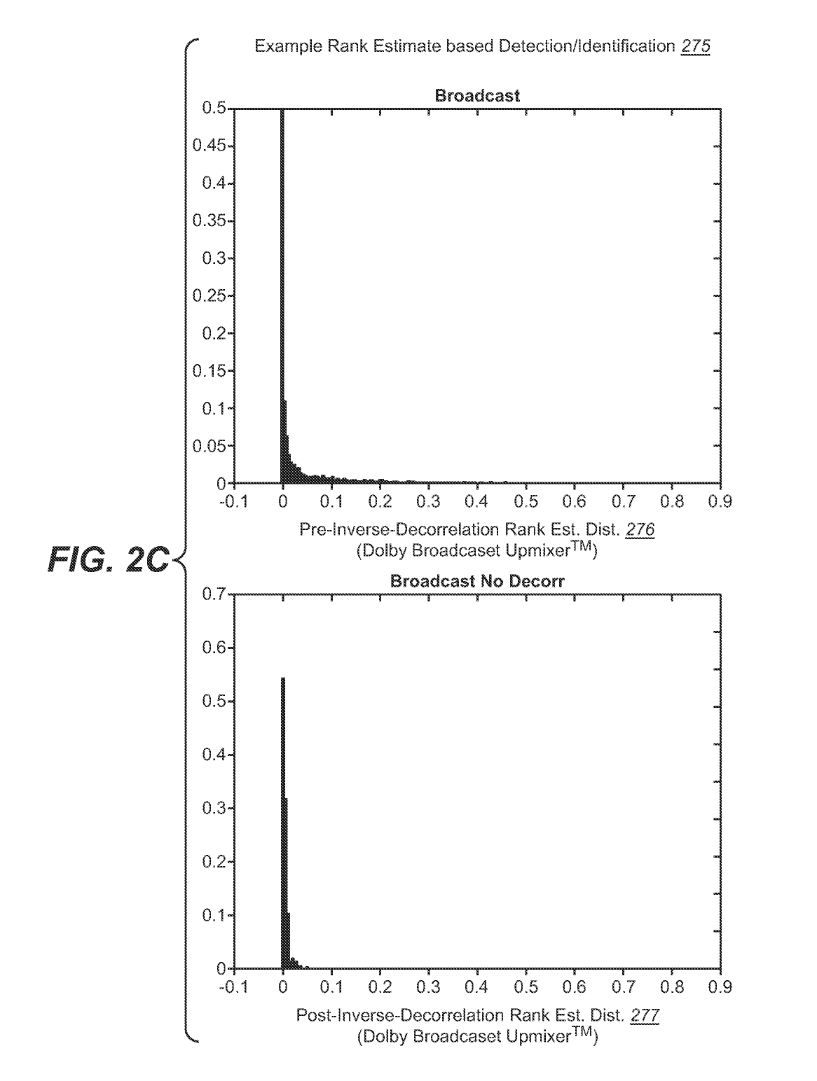

FIG. 3 depicts an example process 300 for computing a speech leakage feature, according to an embodiment of the present invention. In step 301, the audio content in the center channel C is classified. In step 302, a ‘speech_in_center’ value is computed based on the classification of the C channel audio content; more particularly, the portion of the C channel content that comprises speech or speech related components. In step 303, the audio content in each of the L and R (and/or Ls and Rs) channels classified.

In step 304, a ‘speech_intersection’ value, which denotes the percentage of times when there is speech in channel C when there is also speech content detected in channels L and/or R (and/or Ls and/or Rs), is computed based on the classification of channels L and R (and/or Ls and Rs) and the classification of channel C, in which speech_intersection. In step 305, a speech leakage feature (e.g., ‘speech_leakage’) is computed as a ratio of speech_intersection/speech_in_center.

The speech components of discrete 5.1 content are found in channel C thereof. Thus, the speech leakage feature of discrete 5.1 content equals zero (except for, e.g., rare occurrences of speech purposefully added apart from channel C therein). In contrast, upmixed 5.1 content with speech leakage always present has a unity leakage ratio and upmixed content with some speech leakage will have non-zero ratios less than one. In step 306, an embodiment may further compute a ratio of speech component related or other energy levels in channels L and R (and/or Ls and Rs) to channel C energy level.

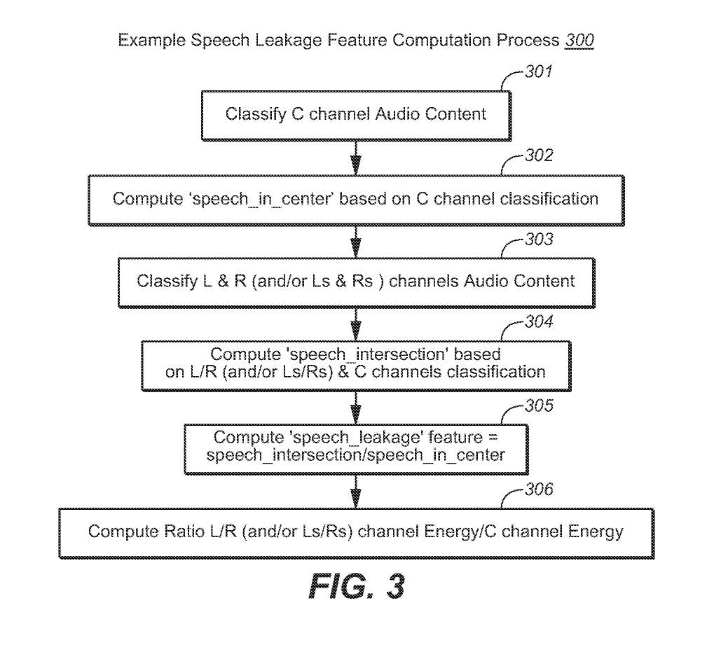

FIG. 4 depicts a plot 40 of signal energy leakage from various multichannel content examples. Plot 40 depicts a scatter plot of two speech leakage features, as computed from different example multi-channel clips created with various upmixers and an example of discrete 5.1 content. The vertical axis scales energy level as a percentage computed from the speech leakage ratio speech_intersection/speech_in_center, as a function of channel L energy level during leakage in decibels (dB) scaled over the horizontal axis.

Example plot items 41 represent discrete 5.1 content, which shows the lowest leakage percentage when compared to upmixed content. Example plot items 42 correspond to upmixed content, which is generated with a broadcast upmixer such as Dolby Broadcast Upmixer™. The speech leakage percentage plot items 42 for content that is upmixed from the broadcast upmixer is generally greater than 0.9 and exceeds the energy level of example plot items 43, which represent leakage for the Prologic II™ upmixer in music mode.

This is consistent with how broadcast upmixers typically operate. For example, broadcast upmixers may be designed to leak the center channel C content to L and R channel, so as to provide a stable sound image in the center for a broader sweet spot. In contrast, speech leakage level and percentages are smaller for Prologic I™ upmixed content, represented by plot items 44. This behavior results from a higher misclassification rate of the speech classifier, due to the low-levels of speech related signal components leaking into the L and R channels.

An embodiment computes the leakage feature based on other audio classification labels as well. For example, the percentage of singing voice leaking into the L/R channels for upmixed music content may be computed. In contrast to the rank analysis features, in which the audio signals have to be aligned accurately in time before computing the covariance matrix for rank estimation, an embodiment computes the leakage analysis features without sensitivity to temporal misalignment between the channels that do not exceed 30 ms or so.

### Example Transfer Function Estimation Between Surround Channels and Reference Channels

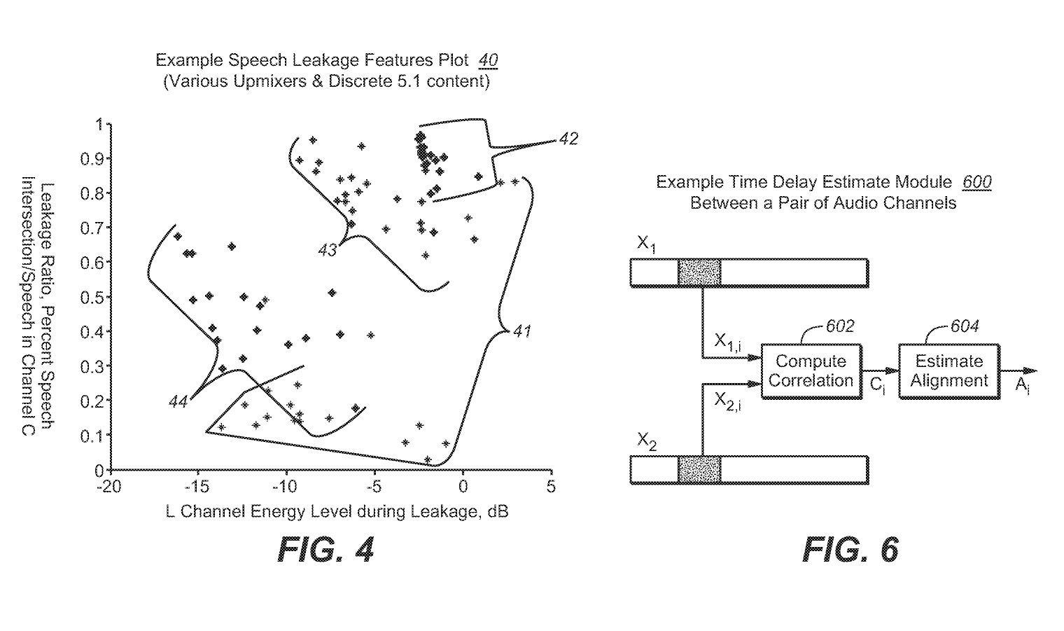

Certain upmixers (e.g., Dolby Prologic™) first derive a reference channel to estimate the signals for deriving the surround channels from stereo content. These upmixers then apply low pass filtering or shelf filtering on the reference channel to derive the surround channel signal. For example, the reference signal for surround channels in Prologic™ upmixer comprises mLᵢₙ−nRᵢₙ, wherein ‘m’ and ‘n’ comprise positive values and wherein ‘Lᵢₙ’ and ‘Rᵢₙ’ comprise input left and right channel signals. A low pass filter (e.g., 7 kHz) or shelf filter may then be applied to suppress the high frequency content that may leak to the surround channels therefrom. FIG. 5A and FIG. 5B depict respectively example low-pass filter response 51 and shelf filter frequency response 52.

To estimate the filter transfer functions, the reference channel that was used to create the surround channel is first estimated. Given the upmixed multichannel channel content, the reference channel is estimated as L-R wherein ‘L’ and refer to the left and right channels of the multi-channel content. With access to the surround channels Ls and Rs, the transfer function estimated based on Equation 4, below.

Tₑₛₜ=P_{(1-r)Ls}/P₍₁₋ᵣ₎₍₁₋ᵣ₎ (4)

In Equation 4, ‘P_{(1-r)Ls}’ represents the cross power spectral density between the reference channel (input) and the surround channel (output) and ‘P₍₁₋ᵣ₎₍₁₋ᵣ₎’ represents the power spectral density of the reference channel (input). The transfer function ‘Tₑₛₜ’ may also be estimated using a least mean squares (LMS) algorithm. The estimated transfer function Tₑₛₜ is then compared to a template transfer function, such as filter response 51 and/or filter response 52.

### Example Time Delay Relationship Between Channel Pairs

Upmixers such as Prologic™ may introduce time delays between front channels and surround channels, so as to decorrelate the surround channels from the front channels. An embodiment functions to estimate time delay between a pair of channels, which allows features to be derived based thereon. Table 1, below provides information about front/surround channel time delay offsets (in ms) relative to L/R signals.

TABLE 1

| | | | Lb/Rb or |
|---|---|---|---|
| Decoder Mode | C Signal | Ls/Rs Signals | Cb Signals |
| Dolby Pro Logic | 0 | 10 | — |
| Dolby Pro Logic II Movie | 0 | 10 | — |
| Dolby Pro Logic IIx Movie | 0 | 10 | 20 |
| Dolby Pro Logic II Music | 2 | 0 | — |
| Dolby Pro Loaic IIx Music | 2 | 0 | 10 |
| Dolby Pro Logic II Game | 0 | 10 | — |
| Dolby pro Logic IIx Game | 0 | 10 | 20 |

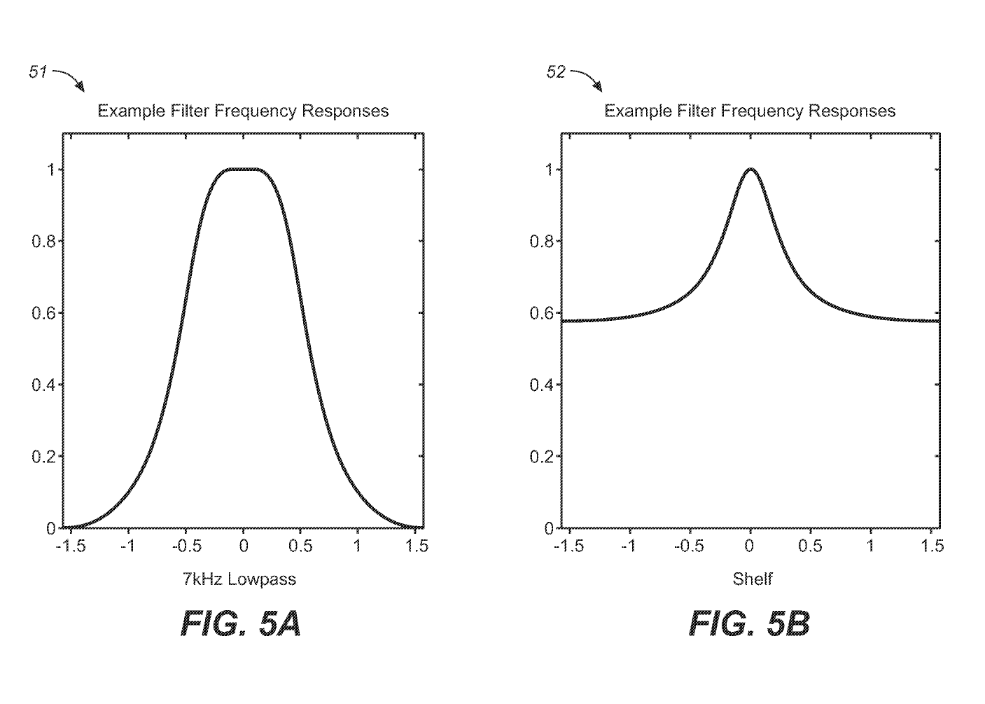

FIG. 6 depicts an example time delay estimation 600 between a pair of audio channels, X₁ AND X₂. In time delay estimation 600, Xᵢ represents the front L/R channels and X₂ represents the Ls/Rs surround channels. Each of the signals is divided into frames of N audio samples and each frame is indexed by ‘i’. Given the N audio samples from two signals corresponding to frame ‘i’, the correlation sequence C, is computed for different shifts (‘w’) as in Equation 5, below.

Cᵢ(w)=Sum(X_{1,i}(n)X_{2,i}(n+w)) (5)

In Equation 5, ‘n’ varies from −N to +N and ‘w’ varies from −N to +N in increments of 1. The time delay estimate between X_{1,i} and X_{2,i} comprises the shift ‘w’ for which the correlation sequence has the maximum value:

Aᵢ=argmax(Cᵢ).

The time-delay estimation allows examination of the time-delay between L/R and Ls/Rs for every frame of audio samples. If the most frequent estimated time delay value is 10 ms, then it is likely that the observed 5.1 channel content has been generated by Prologic™ or Prologic II™ in ‘Movie’/′Game′ mode. Similarly, if the most frequent estimated time delay value between L/R and C is 2 ms, then it is likely that the observed 5.1 channel content has been generated by Prologic II™ in ‘Music’ mode.

### Example Phase Relationship Between Channel Pairs

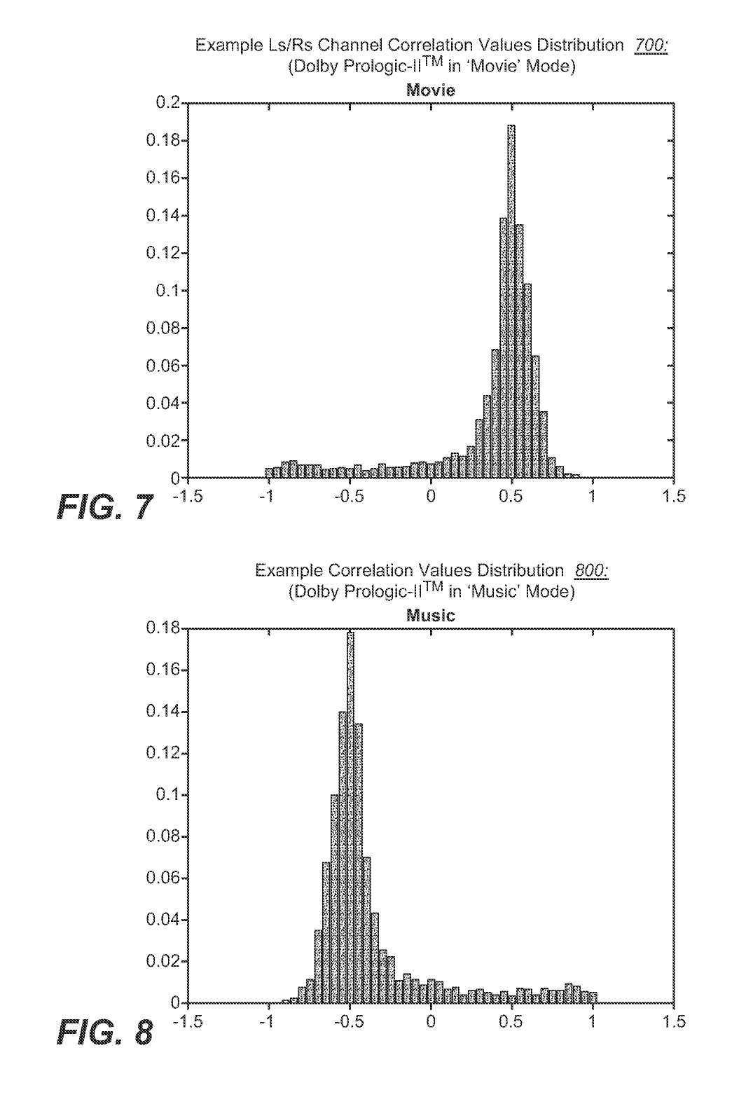

Some upmixers such as Prologic II™ introduce a phase relationship between output surround channels. For example, in its ‘Movie’ mode of Prologic II, the Ls channel is in-phase with the Rs channel, whereas in the ‘Music’ mode of Prologic II, these two channels are 180-degrees out of phase. In the Movie mode, the surround channels are in-phase to allow a content creator to place the object behind the listener, in an acoustically spatial sense. In Music mode by contrast, the out-of-phase surround channels provide more spaciousness. An embodiment derives features that capture phase relationship between surround channels, and thus functions to detect the mode of operation used in upmixing the content. FIG. 7 and FIG. 8 depict correlation value distributions 700 and 800 for an example upmixer in two respective operating modes.

A set of training data is derived by analyzing various multichannel audio content and labeling the features extracted therefrom. The multichannel content from which the labeled training data set is compiled is derived from a certain upmixer, a particular group of related upmixers and discrete instances of multichannel content such as from original audio or various other sources). The machine learning process combines decisions of a set of relatively weak classifiers to arrive at a stronger classifier. Each of these cues is treated as a feature for a weak-classifier.

For example, an embodiment may classify a candidate multichannel content segment for the training data set as having been derived from Prologic II™ upmixer based simply on a phase relationship between surround channels that is computed for that candidate segment. For example, if a correlation between Ls and Rs is determined to be greater than a preset threshold, then the candidate segment may be classified as being derived from Prologic II in its movie and/or music modes. Such a classifier comprises a decision stump.

A decision stump may be expected to have a classification accuracy that exceeds a certain accuracy level (e.g., 0.9). If the accuracy of a given classifier (e.g., 0.5) does not meet its desired accuracy an embodiment combines the weak classifier with one or more other weak classifiers to obtain a stronger classifier that has an accuracy that meets or exceeds the expectation. In an embodiment, a strong classifier comprises at least the expected accuracy.

When the expected accuracy is reached or exceeded, an embodiment stores a final strong classifier for use in processing functions that relate to forensic upmixer detection. While learning the final strong classifier moreover, the Adaboost application also determines a relative significance of each of the weak classifiers and thus the relative significance of the different, various cues.

In an embodiment, the machine learning framework functions over a given a set of training data that has M segments. (M comprises a positive integer.) The M segments comprise example segments, which derived from the multichannel content produced with of a particular ‘target’ upmixer. The M segments also comprise example segments that are derived from upmixers other than the target and from discrete multichannel content, such as an original instance thereof. Each segment in the training data is represented with N features. (N comprises a positive integer.) The N features are derived based on the various features described above, including rank analysis, signal leakage analysis, transfer function estimation, interchannel time delay (or displacement) or phase relationships, etc.

A feature vector that is derived from a segment ‘i’ is represented as a N dimensional feature vector Xᵢ, in which i=1, 2, . . . , M. A label Yᵢ is associated with each of the segments to indicate whether the segment was derived using a particular upmixer (e.g., for Prologic II, Yᵢ=+1) or derived from another upmixer (e.g., Yᵢ=−1). Weak classifiers ‘hₜ’ are defined in which t=1, 2, . . . , T. Each of the hₜ weak classifiers maps an input feature vector (Xᵢ) to a label (Y_{i,t}). The label Y_{i,t} predicted by the weak classifier (hₜ) matches the correct ground truth label Yᵢ at least more than 50% of the M training instances (and thus has an expected accuracy of 0.5).

Given the training data, the Adaboost or other machine learning algorithm selects T such weak classifiers and learns a set of weights αₜ, each element of which corresponds to each of the weak classifiers. An embodiment computes a strong classifier H(x) based on Equation 6, below.

$$H ( x ) = sign ( {\sum }_{t = 1}^{T} {α}_{t} {h}_{t} ( x ) ) \qquad ( 6 )$$

An embodiment may be implemented wherein the machine learning algorithm comprises Adaboost, with a list of features and corresponding feature index (‘idx’) as shown in Table 2 and/or Table 3, below.

TABLE 2
EXAMPLE ADABOOST FEATURES AND INDEX LIST

| | feature |
|---|---|
| list of features | idx |
| rank_est | 1 |
| phase-rel | 2 |
| mean_align_l-r_ls | 3 |
| var_align_l-r_ls | 4 |
| most_frequent l-r_ls | 5 |
| mean_align_l-r_rs | 6 |
| var_align_l-r_rs | 7 |
| most_frequent l-r_rs | 8 |
| mean_align_l_c | 9 |
| var_align_l_c | 10 |
| most_frequent l_c | 11 |
| rank_est _aft_invdecorr | 12 |
| phase-rel_aft_invdecorr | 13 |
| mean_align_l-r_ls_aft_invdecorr | 14 |
| var_align_l-r_ls_aft_invdecorr | 15 |
| most_frequent l-r_ls_aft_invdecorr | 16 |
| mean_align_l-r_rs_aft_invdecorr | 17 |
| var_align_l-r_rs_aft_invdecorr | 18 |
| most_frequent l-r_rs_aft_invdecorr | 19 |
| mean_align_l_c_aft_invdecorr | 20 |
| var_align_l_c_aft_invdecorr | 21 |
| most_frequent l_c_aft_invdecorr | 22 |
| leakage_to_left | 23 |
| leakage_to_right | 24 |
| mean_egy_ratio(left to center) | 25 |
| mean_corr_shelf_template | 26 |
| mean_corr_emulation_template | 27 |
| mean_euc_dist_shelf_template | 28 |
| mean_euc_dist_emulation_template | 29 |
| rank_est - rank_est _aft_invdecorr (1-12) | 30 |
| var_align_l-r_ls - var_align_l-r_ls_aft_invdecorr(4- | |
| 15) | 31 |
| var_align_l-r_rs-var_align_l-r_rs_aft_invdecorr(7-18) | 32 |
| var_align_l_c-var_align_l_c_aft_invdecorr(10-21) | 33 |
| mean_align_l_ls | 34 |
| var_align_l_ls | 35 |
| most_frequent l_ls | 36 |
| mean_align_r_rs | 37 |
| var_align_r_rs | 38 |
| most_frequent r_rs | 39 |
| mean_align_l_ls_aftinvdecorr | 40 |
| var_align_l_ls_aftinvdecorr | 41 |
| most_frequent l_ls_aftinvdecorr | 42 |
| mean_align_r_rs_aftinvdecorr | 43 |
| var_align_r_rs_aftinvdecorr | 44 |
| most_frequent r_rs_aftinvdecorr | 45 |
| var_align_l_ls-var_align_l_ls_aftinvdecorr (35-41) | 46 |
| var_align_r_rs-var_align_r_rs_aftinvdecorr (38-44) | 47 |
| measure of CWC (corr_mat(1,2) + corr(2,3))*0.5 | 48 |
| measure of CWC (corr_mat(4,1)) (L and Ls corr) | 49 |
| measure of CWC (corr_mat(5,3)) (R and Rs corr) | 50 |
| measure of CWC (49 + abs(50))*0.5/48 | 51 |
| relativeegy to center (left) | 52 |
| relativeegy to center (right) | 53 |
| relativeegy to center (ls) | 54 |
| relativeegy to center (rs) | 55 |

TABLE 3
EXAMPLE LIST OF FEATURES USED IN ADABOOST FRAMEWORK TO TRAIN MODELS
FOR DETECTING MULTI-CHANNEL CONTENT FROM VARIOUS SOURCES

1. rank_est: Rank estimate from the covariance matrix computed from the audio chunk
2. phase-rel: Correlation between Ls and Rs
3. mean_align_l-r_ls: Mean of time delay estimate between L-R and Ls
4. var_align_l-r_ls: Variance of time delay estimate between L-R and Ls
5. most_frequent l-r_ls: Most frequent time delay estimate between L-R and Ls
6. mean_align_l-r_rs: Mean of time delay estimate between L-R and Rs
7. var_align_l-r_rs: Variance of time delay estimate between L-R and Rs
8. most_frequent l-r_rs: Most frequent time delay estimate between L-R and Rs
9. mean_align_l_c: Mean of time delay estimate between L and C
10. var_align_l_c: Variance of time delay estimate between L and C
11. most_frequent l_c: Most frequent time delay estimate between L and C
12. rank_est_aft_invdecorr: rank estimate after inverse decorrelation
13. phase-rel_aft_invdecorr: Correlation between Ls and Rs after inverse decorrelation
14. mean_align_l-r_ls_aft_invdecorr: Mean of time delay estimate between L-R and Ls
after inverse decorrelation
15. var_align_l-r_ls_aft_invdecorr: Variance of time delay estimate between L-R and Ls
after inverse decorrelation
16. most_frequent l-r_ls_aft_invdecorr: Most frequent time delay estimate between L-R and Ls
after inverse decorrelation
17. mean_align_l-r_rs_aft_invdecorr: Mean of time delay estimate between L-R and Rs
after inverse decorrelation
18. var_align_l-r_rs_aft_invdecorr: Variance of time delay estimate between L-R and Rs
after inverse decorrelation
19. most_frequent l-r_rs_aft_invdecorr: Most frequent time delay estimate between L-R and Rs
after inverse decorrelation
20. mean_align_l_c_aft_invdecorr: Mean of time delay estimate between L and C
after inverse decorrelation
21. var_align_l_c_aft_invdecorr: Variance of time delay estimate between L and C
after inverse decorrelation
22. most_frequent l_c_aft_invdecorr: Most frequent time delay estimate between L and C
after inverse decorrelation
23. leakage_to_left: Speech leakage from center (C) to left (L)
24. leakage_to_right: Speech leakage from center (C) to left (R)
25. mean_egy_ratio(left to center): Energy ratio between left and center
26. mean_corr_shelf_template: Transfer function estimation feature (comparison to shelf filter
template in terms of correlation)
27. mean_corr_emulation_template: Transfer function estimation feature (comparison to 7 khz filter
template in terms of correlation)
28. mean_euc_dist_shelf_template: Transfer function estimation feature (comparison to shelf filter
template in terms of euclidean distance)
29. mean_euc_dist_emulation_template: Transfer function estimation feature (comparison to 7 khz
filter template in terms of euclidean distance)
30. rank_est - rank_est _aft_invdecorr (1-12): change in rank estimate after inverse decorrelation
31. var_align_l-r_ls - var_align_l-r_ls_aft_invdecorr(4-15): change in variance of time delay estimate
between L-R and Ls after inverse decorrelation
32. var_align_l-r_rs-var_align_l-r_rs_aft_invdecorr(7-18): change in variance of time delay estimate
between L-R and Rs after inverse decorrelation
33. var_align_l_c-var_align_l_c_aft_invdecorr(10-21): change in variance of time delay estimate
between L and C after inverse decorrelation
34. mean_align_l_ls: Mean of time delay estimate between L and Ls
35. var_align_l_ls: Variance of time delay estimate between L and Ls
36. most_frequent l_ls: Most frequent time delay estimate between L and Ls
37. mean_align_r_rs: Mean of time delay estimate between R and Rs
38. var_align_r_rs: Variance of time delay estimate between R and Rs
39. most_frequent r_rs: Most frequent time delay estimate between R and Rs
40. mean_align_l_ls_aftinvdecorr: Mean of time delay estimate between L and Ls after inverse
decorrelation
41. var_align_l_ls_aftinvdecorr: Variance of time delay estimate between L and Ls after inverse
decorrelation
42. most_frequent l_ls_aftinvdecorr: Most frequent time delay estimate between L and Ls after
inverse decorrelation
43. mean_align_r_rs_aftinvdecorr: Mean of time delay estimate between R and Rs after inverse
decorrelation
44. var_align_r_rs_aftinvdecorr: Variance of time delay estimate between R and Rs after inverse
decorrelation
45. most_frequent r_rs_aftinvdecorr: Most frequent time delay estimate between R and Rs after
inverse decorrelation
46. var_align_l_ls-var_align_l_ls_aftinvdecorr (35-41): Change in variance of time delay estimate
between L and Ls after inverse decorrelation
47. var_align_r_rs-var_align_r_rs_aftinvdecorr (38-44): Change in variance of time delay estimate
between R and Rs after inverse decorrelation
48. measure of CWC (corr_mat(1,2) + corr(2,3))*0.5: Average correlation between L, C andR. i.e
0.5(corr(L,C) + corr(R,C)). This is an indicator of Center Width Control (CWC) settings. That is, if the
center signal is added to L and R, this feature value is expected to be large.
49. measure of CWC (corr_mat(4,1)) (L and Ls corr): Correlation between L and Ls
50. measure of CWC (corr_mat(5,3)) (R and Rs corr): Correlation between R and Rs
51. measure of CWC (49 + abs(50))*0.5/48: (Corr(L,Ls) + Corr(R,Rs))*0.5/
(Corr(L,Ls) + Corr(R,Rs))*0.5. Another measure of center width control (CWC) settings.
52. relativeegy to center (left): Relative energy in left channel compared to center channel in db
53. relativeegy to center (right): Relative energy in right channel compared to center channel in db
54. relativeegy to center (ls): Relative energy in Ls channel compared to center channel in db
55. relativeegy to center (rs): Relative energy in Rs channel compared to center channel in db

### Example Computer System Implementation

Embodiments of the present invention may be implemented with a computer system, systems configured in electronic circuitry and components, an integrated circuit (IC) device such as a microcontroller, a field programmable gate array (FPGA), or another configurable or programmable logic device (PLD), a discrete time or digital signal processor (DSP), an application specific IC (ASIC), and/or apparatus that includes one or more of such systems, devices or components. The computer and/or IC may perform, control or execute instructions, which relate to adaptive audio processing based on forensic detection of media processing history, such as are described herein. The computer and/or IC may compute, any of a variety of parameters or values that relate to the forensic detection of upmixing in multi-channel audio content based on analysis of the content, e.g., as described herein. The forensic detection of upmixing in multi-channel audio content based on analysis of the content embodiments may be implemented in hardware, software, firmware and various combinations thereof

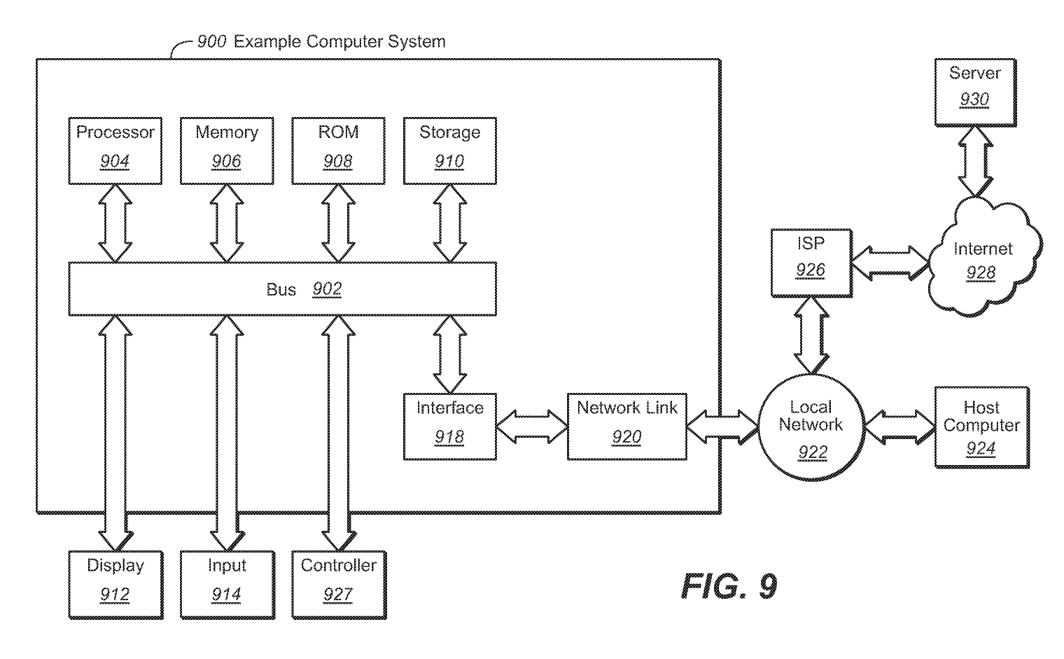

FIG. 9 depicts an example computer system platform 900, with which an embodiment of the present invention may be implemented. Computer system 900 includes a bus 902 or other communication mechanism for communicating information, and a processor 904 coupled with bus 902 for processing information. Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904.

Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions. Processor 904 may perform one or more digital signal processing (DSP) functions. Additionally or alternatively, DSP functions may be performed by another processor or entity (represented herein with processor 904).

Computer system 900 may be coupled via bus 902 to a display 912, such as a liquid crystal display (LCD), cathode ray tube (CRT), plasma display or the like, for displaying information to a computer user. LCDs may include HDR/VDR and/or WCG capable LCDs, such as with dual or N-modulation and/or back light units that include arrays of light emitting diodes. An input device 914, including alphanumeric and other keys, is coupled to bus 902 for communicating information and command selections to processor 904. Another type of user input device is cursor control 916, such as haptic-enabled “touch-screen” GUI displays or a mouse, a trackball, or cursor direction keys for communicating direction information and command selections to processor 904 and for controlling cursor movement on display 912. Such input devices typically have two degrees of freedom in two axes, a first axis (e.g., x, horizontal) and a second axis (e.g., y, vertical), which allows the device to specify positions in a plane.

Embodiments of the invention relate to the use of computer system 900 for forensic detection of upmixing in multi-channel audio content based on analysis of the content. An embodiment of the present invention relates to the use of computer system 900 to compute processing functions that relate to forensic detection of upmixing in multi-channel audio content based on analysis of the content, as described herein. According to an embodiment of the invention, an audio signal is accessed, which has two or more individual channels and is generated with a processing operation. The audio signal is characterized with one or more sets of attributes that result from respective processing operations. Features that are extracted from the accessed audio signal each respectively correspond to the attribute sets. Based on analysis of the extracted features, it is determined whether the processing operations include upmixing, which was used to derive the individual channels in a multi-channel audio file. The determination allows identification of a particular upmixer that generated the accessed audio signal. The upmixing determination includes computing a score for the extracted features based on a statistical learning model, which may be computed based on an offline training set. This feature is provided, controlled, enabled or allowed with computer system 900 functioning in response to processor 904 executing one or more sequences of one or more instructions contained in main memory 906.

Such instructions may be read into main memory 906 from another computer-readable medium, such as storage device 910. Execution of the sequences of instructions contained in main memory 906 causes processor 904 to perform the process steps described herein. One or more processors in a multi-processing arrangement may also be employed to execute the sequences of instructions contained in main memory 906. In alternative embodiments, hard-wired circuitry may be used in place of or in combination with software instructions to implement the invention. Thus, embodiments of the invention are not limited to any specific combination of hardware, circuitry, firmware and/or software.

The terms “computer-readable medium,” “computer-readable storage medium” and/or “non-transitory computer-readable storage medium” as used herein may refer to any tangible, non-transitory medium that participates in providing instructions to processor 904 for execution. Such a medium may take many forms, including but not limited to, non-volatile media, volatile media, and transmission media. Non-volatile media includes, for example, optical or magnetic disks, such as storage device 910. Volatile media includes dynamic memory, such as main memory 906. Transmission media includes coaxial cables, copper wire and other conductors and fiber optics, including the wires that comprise bus 902. Transmission media can also take the form of acoustic (e.g., sound, sonic, ultrasonic) or electromagnetic (e.g., light) waves, such as those generated during radio wave, microwave, infrared and other optical data communications that may operate at optical, ultraviolet and/or other frequencies.

Common forms of computer-readable media include, for example, a floppy disk, a flexible disk, hard disk, magnetic tape, or any other magnetic medium, a CD-ROM, any other optical medium, punch cards, paper tape, any other legacy or other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 904 for execution. For example, the instructions may initially be carried on a magnetic disk of a remote computer. The remote computer can load the instructions into its dynamic memory and send the instructions over a telephone line using a modem. A modem local to computer system 900 can receive the data on the telephone line and use an infrared transmitter to convert the data to an infrared signal. An infrared detector coupled to bus 902 can receive the data carried in the infrared signal and place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card or a digital subscriber line (DSL), cable or other modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) (or telephone switching company) 926. In an embodiment, local network 922 may comprise a communication medium with which encoders and/or decoders function. ISP 926 in turn provides data communication services through the worldwide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are exemplary forms of carrier waves transporting the information.

Computer system 900 can send messages and receive data, including program code, through the network(s), network link 920 and communication interface 918.

In the Internet example, a server 930 might transmit a requested code for an application program through Internet 928, ISP 926, local network 922 and communication interface 918. In an embodiment of the invention, one such downloaded application provides for forensic detection of upmixing in multi-channel audio content based on analysis of the content, as described herein.

The received code may be executed by processor 904 as it is received, and/or stored in storage device 910, or other non-volatile storage for later execution. In this manner, computer system 900 may obtain application code in the form of a carrier wave.

### Example IC Device Platform

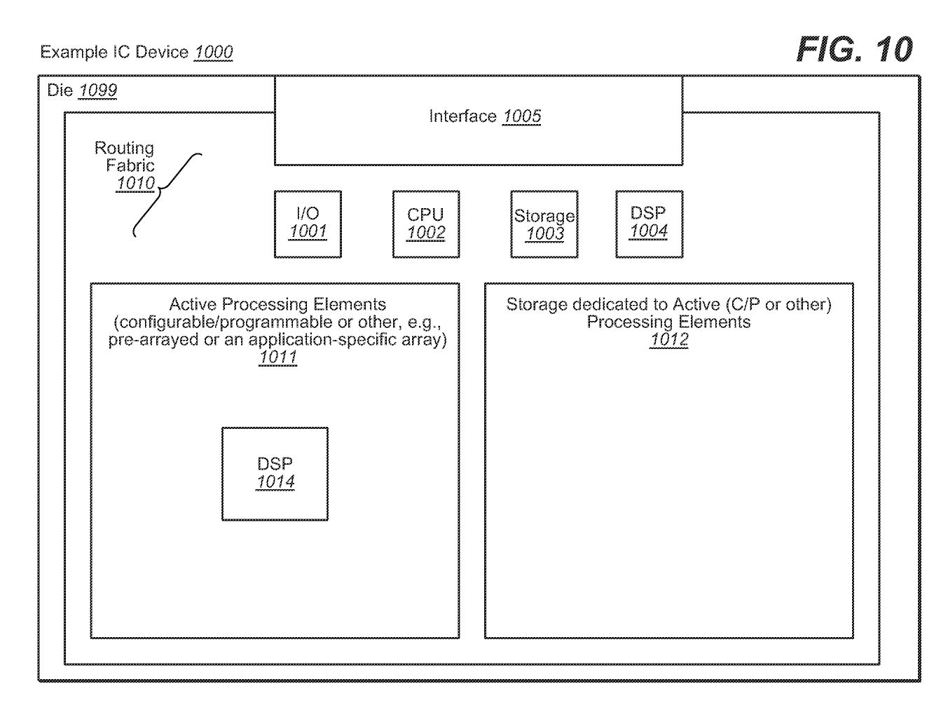

FIG. 10 depicts an example IC device 1000, with which an embodiment of the present invention may be implemented for forensic detection of upmixing in multi-channel audio content based on analysis of the content, as described herein. IC device 1000 may comprise a component of an encoder and/or decoder apparatus, in which the component functions in relation to the enhancements described herein. Additionally or alternatively, IC device 1000 may comprise a component of an entity, apparatus or system that is associated with display management, production facility, the Internet or a telephone network or another network with which the encoders and/or decoders functions, in which the component functions in relation to the enhancements described herein.

IC device 1000 may have an input/output (I/O) feature 1001. I/O feature 1001 receives input signals and routes them via routing fabric 1050 to a central processing unit (CPU) 1002, which functions with storage 1003. I/O feature 1001 also receives output signals from other component features of IC device 1000 and may control a part of the signal flow over routing fabric 1050. A digital signal processing (DSP) feature 1004 performs one or more functions relating to discrete time signal processing. An interface 1005 accesses external signals and routes them to I/O feature 1001, and allows IC device 1000 to export output signals. Routing fabric 1050 routes signals and power between the various component features of IC device 1000.

Active elements 1011 may comprise configurable and/or programmable processing elements (CPPE) 1015, such as arrays of logic gates that may perform dedicated or more generalized functions of IC device 1000, which in an embodiment may relate to adaptive audio processing based on forensic detection of media processing history. Additionally or alternatively, active elements 1011 may comprise pre-arrayed (e.g., especially designed, arrayed, laid-out, photolithographically etched and/or electrically or electronically interconnected and gated) field effect transistors (FETs) or bipolar logic devices, e.g., wherein IC device 1000 comprises an ASIC. Storage 1002 dedicates sufficient memory cells for CPPE (or other active elements) 1001 to function efficiently. CPPE (or other active elements) 1015 may include one or more dedicated DSP features 1025.

Thus, an example embodiment relates to accessing an audio signal, which has two or more individual channels and is generated with a processing operation. The audio signal is characterized with one or more sets of attributes that result from respective processing operations. Features that are extracted from the accessed audio signal each respectively correspond to the attribute sets. Based on analysis of the extracted features, it is determined whether the processing operations include upmixing, which was used to derive the individual channels in a multi-channel audio file. The determination allows identification of a particular upmixer that generated the accessed audio signal. The upmixing determination includes computing a score for the extracted features based on a statistical learning model, which may be computed based on an offline training set.

### EQUIVALENTS, EXTENSIONS, ALTERNATIVES AND MISCELLANEOUS

Example embodiments that relate to forensic detection of upmixing in multi-channel audio content based on analysis of the content are thus described. In the foregoing specification, embodiments of the present invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method, comprising:
accessing or receiving an audio signal that has two or more individual channels;
extracting one or more features from the accessed audio signal; and
determining, based on the extracted features, whether the audio signal was upmixed from audio content that has fewer channels than the accessed or received audio signal.

2. The method as recited in claim 1 wherein the determination comprises identifying a particular upmixer generated the accessed audio signal.

3. The method as recited in claim 1, wherein the upmixing determination comprises computing a score for the extracted features based on a statistical learning model.

4. The method as recited in claim 3, wherein the statistical learning model is computed based on an offline training set.

5. The method as recited in claim 3, wherein the statistical learning model comprises one or more of:
an Adaptive Boosting (AdaBoost) algorithm;
a Gaussian Mixture Model (GMM);
a Support Vector Machine (SVM); or
a machine learning process.

6. The method as recited in claim 1, wherein the extracted features comprise one or more of:
a rank analysis of the accessed audio signal;
an analysis of a leakage of at least one component of the signal over the two or more channels of the accessed audio signal;
an estimation of a transfer function between at least a pair of the more than two channels;
an estimation of a phase relationship between at least a pair of the two or more channels; or
an estimation of a time delay relationship between at least a pair of the two or more channels.

7. The method as recited in claim 6, wherein the estimation one or more of the time delay relationship or the phase relationship is estimated by computing a correlation between each of the channels of the pair.

8. The method as recited in claim 6, wherein the rank analysis is performed in on one or more of:
the accessed audio signal broadly in a time domain; or
in each of a plurality of frequency bands that correspond to the two or more channels of the accessed audio signal.

9. The method as recited in claim 8, wherein:
the rank analysis that is performed on the accessed audio signal in the time domain comprises a wideband rank analysis; and
upon performing the wideband time domain based rank analysis and the rank analysis in each of the corresponding frequency bands, the method further comprises:
comparing the wideband time domain rank analysis with the rank analysis in each of the frequency bands;
wherein the comparison detects whether the upmixer comprises a wideband or a multi-band upmixer.

10. The method as recited in claim 6, further comprising:
aligning temporally each of the channel of the channel pair;
wherein the rank analysis is performed after the temporal alignment.

11. The method as recited in claim 6, wherein the rank analysis comprises an initial ranking, the method further comprising:
upon completing the initial rank analysis, performing an inverse decorrelation over at least a pair of surround sound channels of the accessed audio signal; and
upon the inverse decorrelation performance, repeating the rank analysis based, as least in part, on a feature that is ranked with the repeated rank analysis in a subsequent ranking.

12. The method as recited in claim 11, further comprising comparing the subsequent ranking from the repeated rank analysis with the initial ranking that was performed before inverse decorrelation.

13. The method as recited in claim 6, wherein the signal component leakage analysis relates to detecting or classifying a speech related signal component contemporaneously in each of at least two of the channels of the audio signal.

14. The method as recited in claim 13, wherein one or more of the at least two channels comprises a channel other than a center channel.

15. The method as recited in claim 6, wherein a discrete instance of the multi-channel audio content comprises a musical voice component in at least a complementary pair of channels, wherein the signal component leakage analysis feature relates to detecting or classifying the musical voice related component in at least one channel other than the complementary channel pair.

16. The method as recited in claim 6, wherein a discrete instance of the multi-channel audio content comprises one or more components that relate to one or more of an ambient, or scene, sound or noise in at least one particular channel, wherein the signal component leakage analysis feature relates to detecting or classifying the ambient, or scene, sound or noise related component in at least one channel other than the particular channel.

17. The method as recited in claim 6, wherein the transfer function estimation is performed based on:
a cross-power spectral density; and
an input power spectral density.

18. The method as recited in claim 2, wherein the transfer function estimation is performed based on a least mean squares (LMS) algorithm.

19. The method as recited in claim 1, wherein the upmixing determination further comprises:
analyzing the extracted features over a duration of time; and
computing a set of descriptive statistics based on the analyzed features, wherein the descriptive statistics include at least a mean value, a variance value, and a most frequent value that are computed over the extracted features.

20. A non-transitory computer readable storage medium, comprising instructions that are encoded and stored therewith, which when executed with a computer processor cause, control or program the computer processor to perform forensic upmixer detection process, wherein the process comprises:
accessing or receiving an audio signal that has two or more individual channels, wherein the audio signal comprises one or more sets of attributes;
extracting one or more features from the accessed audio signal, wherein the extracted features each respectively correspond to the one or more sets of attributes; and
determining, based on the extracted features, whether the audio signal was upmixed from audio content that has fewer channels than the accessed or received audio signal.

21. The non-transitory computer readable storage medium as recited in claim 20 wherein the process further comprises identifying a particular upmixer generated the accessed audio signal.

22. A system, comprising:
means for accessing or receiving an audio signal that has two or more individual channels, wherein the audio signal comprises one or more sets of attributes;
means for extracting one or more features from the accessed audio signal, wherein the extracted features each respectively correspond to the one or more sets of attributes; and
means for determining, based on the extracted features, whether the audio signal was upmixed from audio content that has fewer channels than the accessed or received audio signal.

23. The system as recited in claim 22, further comprising means for identifying a particular upmixer generated the accessed audio signal.
